(19) United States
(12) Patent Application Publication
(10) Pub. No.: US 2009/0081805 A1
(43) Pub. Date: Mar. 26, 2009

(54) Method for finding active ingredients from chemical and biological systems

(75) Inventors: Foo-tim Chau, Kowloon (HK); Cheng-jian Xu, Kowloon (HK)

Correspondence Address: The Hong Kong Polytechnic University;Suite 600, Mailbox #119, 1800 Diagonal Road, Alexandria, VA, 22314, US

(73) Assignee: The Hong Kong Polytechnic University, Kowloon (HK)

(21) Appl. No.: 11/902,536

(22) Filed: Sep. 24, 2007

(51) Int. Cl. G01N 30/00; G01N 30/02; G01N 31/00

(52) U.S. Cl. 436/161; 436/173; 702/22

(57) ABSTRACT

The present invention relates to a method for finding active ingredients/groups of constitutes from a multi-component system that are active as indicated by specific or a group of activity test. The method involves the use of a hyphenated instrument for determining the active ingredients.

### BACKGROUND

Multi-component systems are often found to be effective for certain activities. For example, sho-saiko-to, and extract of seven Chinese herbs, are found to help prevent liver cancer in patients with cirrhosis. The combined drug, known as a “cocktail”, has helped change AIDS from being an automatic death sentence to what is now often a chronic, but manageable, disease. Yet, it is difficult to find the components within the system that are responsible for the activity, since in multi-component systems, the overall effect is derived not only from a single compound or a component but also from several or many compounds generating additive or synergistic effects. The conventional approach for analyzing multi-component mixtures was often resorting to separation procedures, which are tedious with no guarantee of success. Moreover, the activities of components often change during the isolation and purification steps due to decomposition of other complication.

It is an object of the present invention to overcome the disadvantages and problems in the prior art, namely by developing a method capable of finding components within a system that are responsible for bioactivity.

### DESCRIPTION

The present invention proposes a method to find the relation between a chromatographic fingerprint and its bio/chemo activity.

The method is of importance in quality control of herbal medicine because it can find the relationship between its pharmaceutical activity and chemical components, make the underlying mechanism elucidated by thorough and systematic research at a molecular level, and provide scientific base for the evaluation of herbal medicines, establish integrated evaluation system and develop fingerprints containing the groups of active constitutes or individual active components and that is responsible for curative effects. The present method also provides a much faster way to discover the active ingredients from herbal medicines as drug leads in drug development.

These and other features, aspects, and advantages of the apparatus and methods of the present invention will become better understood from the following description, appended claims, and accompanying drawings where:

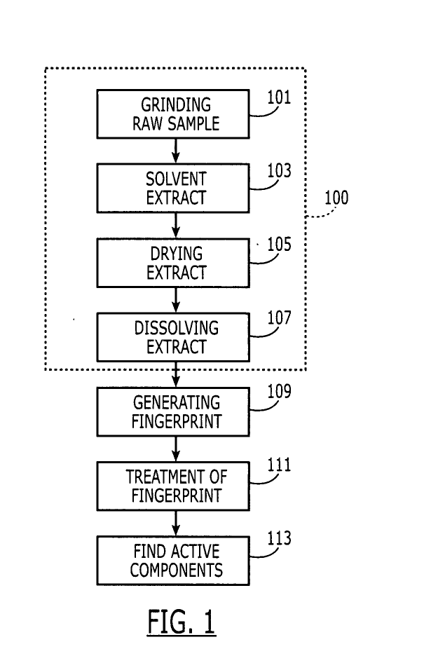

FIG. 1 shows the method of the present invention;

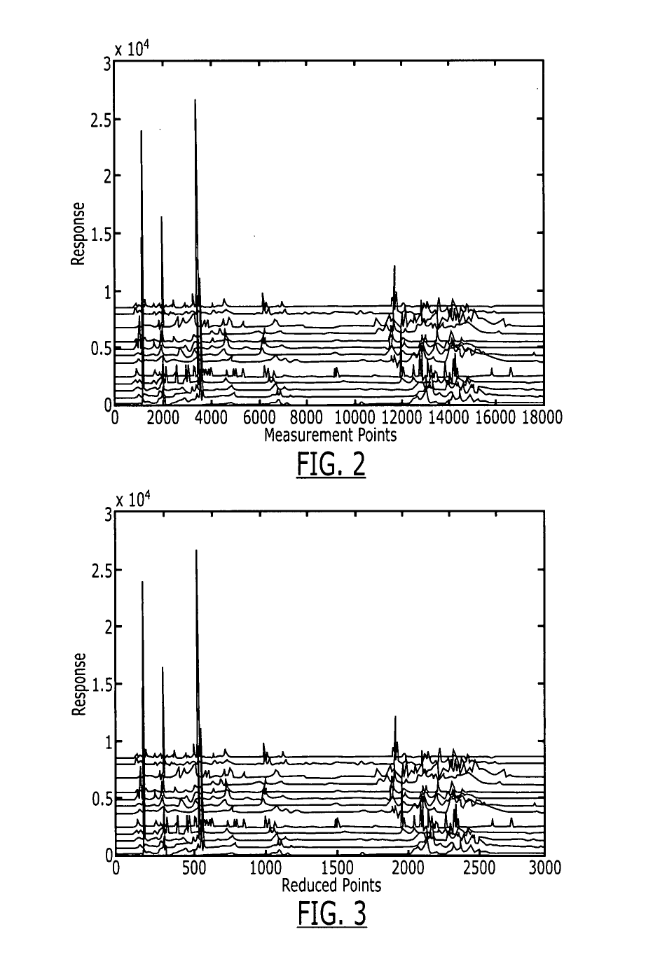

FIG. 2 shows fingerprints obtained from a system in accordance with the method;

FIG. 3 shows the reduced UV data set of the fingerprints;

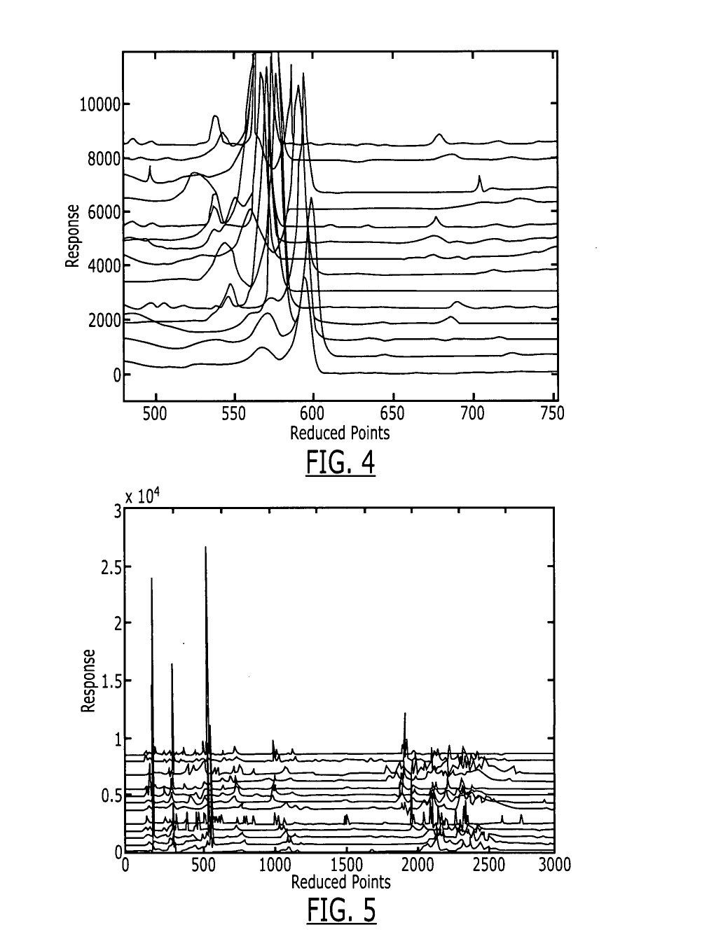

FIG. 4 shows the evidence of time shifts;

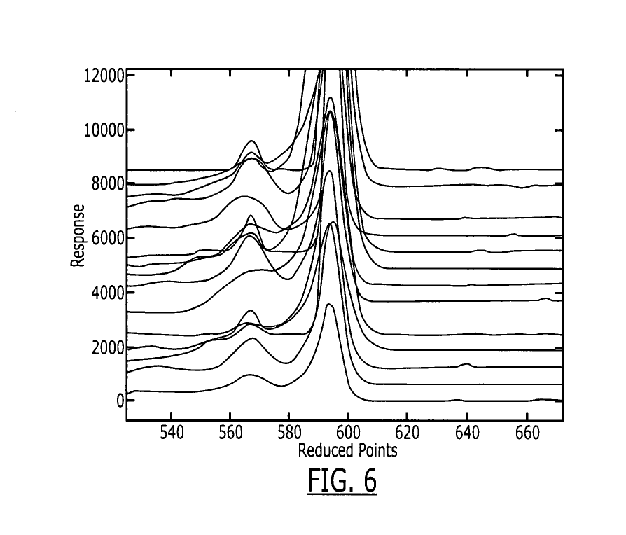

FIGS. 5 & 6 show the chromatograms following signal treatment;

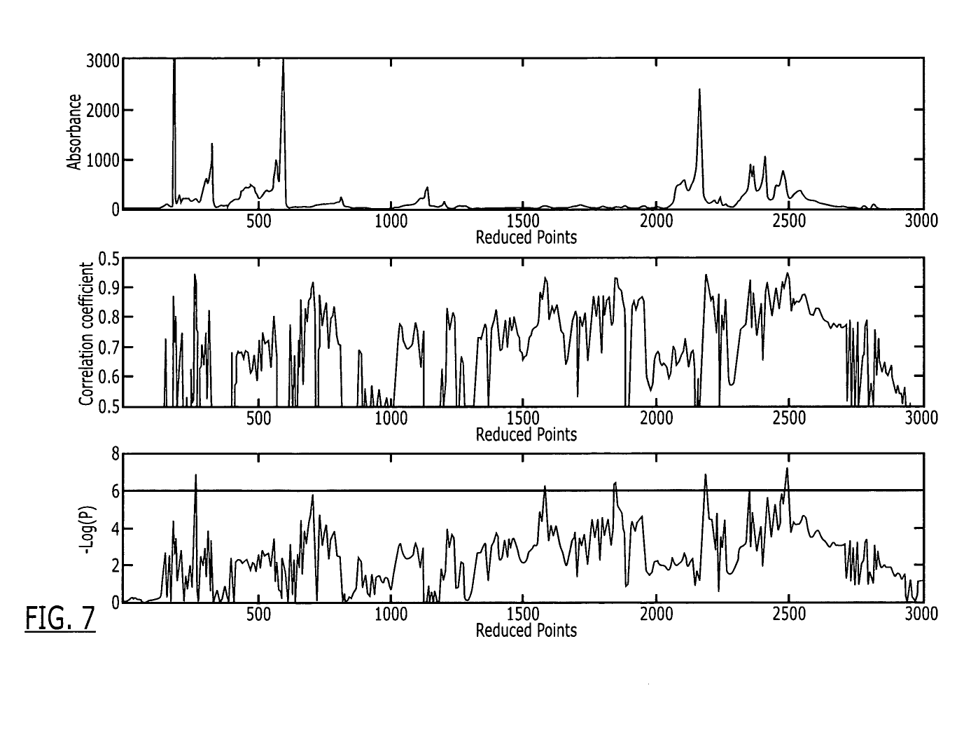

FIG. 7 shows graphs to find the active ingredients;

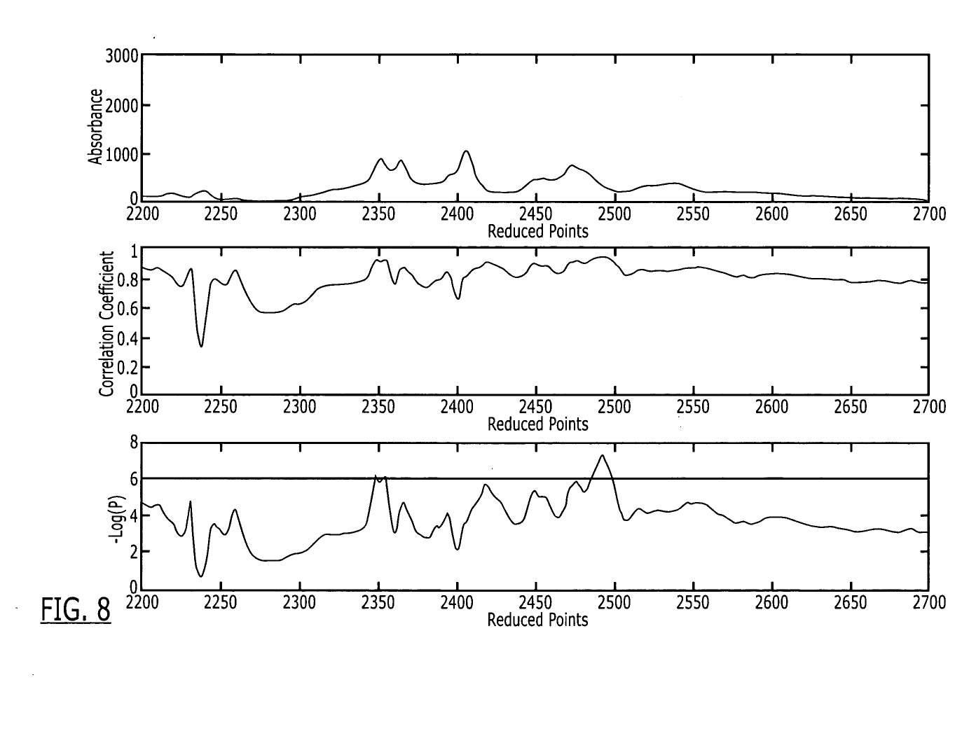

FIG. 8 exhibits the active components of the systems; and

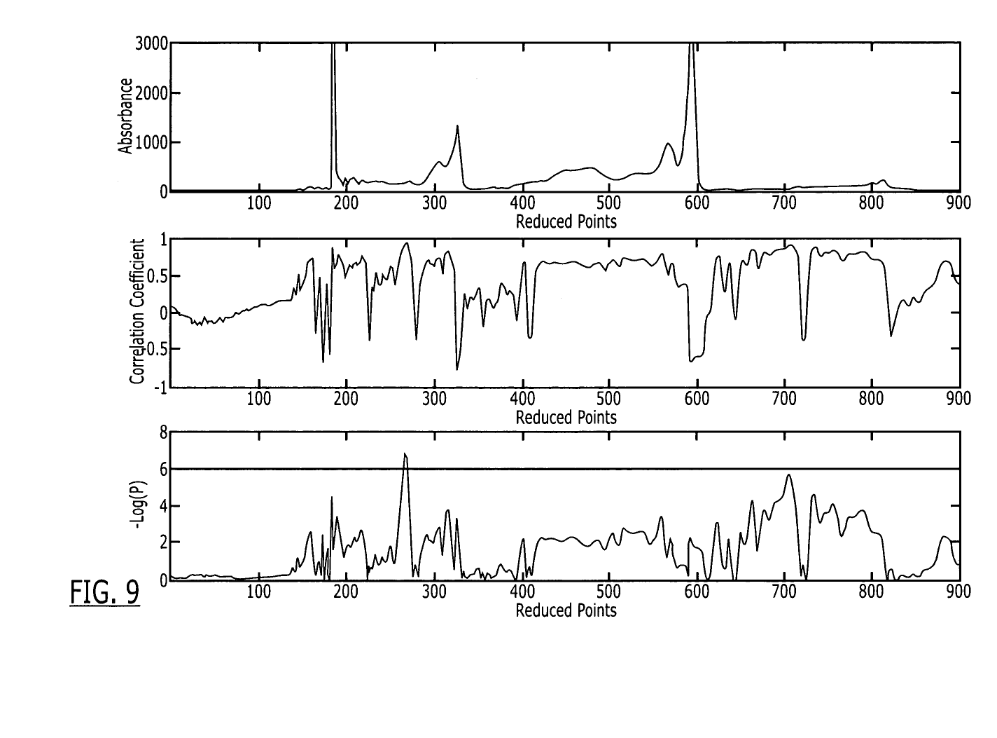

FIG. 9 further exhibits active components.

The following description of certain exemplary embodiment(s) is merely exemplary in nature and is in no way intended to limit the invention, its application, or uses. Throughout this description, the term “natural products” shall refer to naturally occurring organic compounds including whole plants, herbs, glands, or other animal organs, extracts, secretions, and vegetable saps.

The term “fingerprint” shall refer to a chromatogram or electropherogram representing all the detectable chemical components present in the extract and being separated so as to identify and characterize the system.

The term “active ingredient” shall refer to a component of a natural ingredient primarily responsible for the known effect of the natural ingredient.

The term “multi-component system” shall include herbal medicine, dietary supplements, vitamins multi-vitamins supplements, and the like. The term “herbal medicine” shall refer to one or more crushed extracted, evaporated, distilled, ground, chopped natural ingredients intended to be adminitered as preventative or curative agent.

Now, to FIGS. 1-9,

The present invention relates to a method for finding active ingredients and groups of constitutes from a multi-component system, such as an herbal medicine. The method is suitable for discovering lead compounds in the drug discovery process. The method is applicable to herbal medicine systems, liquor such as wine, argricultural plants, and multi-component systems.

FIG. 1 is an embodiment of the method of the present invention. The method has as its goal the presentation of active constituents that are likely present in a multi-component system and probably responsible for its efficacy.

The method is initiated by preparing a sample of the multi-component system 100. Firstly, the system is ground 101. This can be performed by methods known in the art, including mortar and pestel, or ball milling. The system should be ground to the point where it is a very fine powder.

The multi-component system used in the present invention can be selected from the group consisting herbal medicines, traditional medicines, herbs, dietary supplements, and the like. The system is comprised of natural products and generally excludes chemically-modified ingredients, such as chemically synthesized compounds. The system should reflect a formula that has been standardized, i.e., the ingredients and their amounts in the system have been finalized. The multi-component system in its administered form is preferably a solid, oral dosage such as tablet, capsule, dragee, and the like. The system is preferably uncoated or does not contain an external binder.

Solvent Extracts are prepared 103 by refluxing the ground system with solvent/water mixtures. In one embodiment, multiple solvent extracts are prepared such as, for example, 5 solvent extracts. In such an embodiment, the solvent extracts differ by the percentage of ethanol within the solvent, for example solvent #1: 0% ethanol, solvent #2: 25% ethanol, solvent #3: 50% ethanol, solvent #4: 75% ethanol and solvent #5: 100% ethanol.

The residue of the extracts are then filtered.

The filtered extracts are then dried 105 to evaporate the solvent. Evaporation may occur by vacuum. The extract preferably is further dried with a freezer dryer for a period of between 18 to 30 hours, preferably, 24 hours.

The dried extract is then dissolved 107 with its extracting solvent. The concentration of the extract/solvent solution can be from 3 mg/ml to 7 mg/ml. A fingerprint of the dissolved extract is then generated 109. The generation of the fingerprint 109 is preferably performed by a hyphenated instrument, for example gas chromatography/mass spectrophotometer (GC/MS), high performance liquid chromatography/diode array detector (HPLC/DAD), capillary electrophoresis/diode array detector (CE/DAD), and the like. The fingerprint represents relative concentrations and they are proportional to their chromatographic responses. However, a same response in different experiment does not stand for same concentration because experiment variations are present and unavoidable.

When the multi-component system is measured by hyphenated instruments, the two-dimensional bilinear data obtained can be expressed as an absorbance matrix Xm.n. Here m is the number of measured spectra and n the number of variables (e.g. mass to charge ratios or wavelengths). The global/total fingerprint of the multi-component system can be obtained as the sum of the responses at each mass to charge ratio.

The resultant fingerprint is then treated 111 prior to data analysis. Treatment 111 results in data, for example chromatographic data, that is of equal length, and when chromatograms are placed as rows in a data matrix, the apexes of the corresponding peaks should be in the same columns of the matrix. Treatment 111 is necessary because of peak shifts seen along the time axis. These shifts can be caused by variations in mobile phase composition or column temperature, column aging, instrument instability, etc. In the present method, target peak alignment (TPA) is utilized to correct retention shifts.

While not to be bound by theory, the main idea of TPA is to fit the unknown warp function by identifying corresponding peaks in the finger prints. To obtain this, a local target factor analysis (TFA), for example window target-testing factor analysis (WTTFA), is used to identify the target components in the fingerprints. WTTFA is used to test where a specified component is present in a mixture.

After finding target components and their retention times by TFA, the fingerprint can be divided into many sections. In each section, the five points in which target peaks achieve the highest intensity will be used for linear interpolation.

In an example,

Suppose a section having starting point at position xₛ and end point at position Xₑ is warped to starting position x′ₛ and end position x′ₑ by calculating

$$y j = \frac{j}{{x}_{e}^{′} - {x}_{s}^{′}} ( {x}_{e} - {x}_{s} ) + {x}_{s} ; j = 0 , … , {x}_{e}^{′} - {x}_{s}^{′}$$

and then calculating the value of y′(x′ₛ+j) by linear interpolation between the points in y adjacent to yj. Here y′ and y are the referenced fingerprint and the fingerprint under alignment, respectively.

Following fingerprint treatment, active components should be located 113. Active components refers to the components or constituents that exhibit potential chemical or biological activity. In one embodiment, chemical or biological activity can be shown by performing antioxidant activity test. Antioxidants are well-known to be used in the hope of maintaining health and preventing diseases. Antioxidant activity tests can include but are not limited to folin-ciocalteu method, trolox equipment antioxidant capacity (TEAC), TEAC with manganese dioxide, TEAC assay with ABTS and potassium persulfate, total radical-trapping antioxidant parameter (TRAP assay), 2,2-dipheny-1-picryl hydrazyl (DPPH assay), N,N-dimethyl-p-phenylenediamine (DMPD), photochemilominescence(PCL assay), ferric reducing ability of plasma (FRAP assay), and the like. Antioxidant activity methods as taught by Schlesier et al. (“Assessment of Antioxidant activity by using different in vitro methods”) are suitable for the present invention, and incorporated herein by reference.

In the fingerprints, to find the bioactive constituents 113, regions which are the most responsible for observed chemical/biological activity is focused upon. In order to find the bioactive constituents 113, correlation analysis (QA) can be used. A hypothesis of correlation between fingerprint peaks and standardized component peaks is made. Correlation coefficient and p-values can be used to test the hypothesis.

As known in the art, the spectra from the hyphenated instrument is transformed into a set of 2D correlation spetra by cross-correlation analysis. The correlation function can be given as:

$$Φ ( {v}_{1} , {v}_{2} ) + i Ψ ( {v}_{1} , {v}_{2} ) = \frac{1}{π ( {T}_{max} - {T}_{min} )} {\int }_{0}^{∞} {\tilde{Y}}_{1} ( w ) \cdot {{Y}_{2}^{*} ( w )}_{dw}$$

The p-values are the probabilities of getting a correlation as large as the observed value by random chance when the true correlation is zero. In one embodiment, the p-value is small, for example 10⁻⁶. In such embodiment, the correlation is considered significant.

### EXAMPLE

Chromatographic grade of methanol and acetonitrile was obtained from TEDIA (USA). Ethanol was supplied from International Laboratory (USA). 1,1-Dipheny-20picrylhydrazyl (DPPH) powder and formic acid were purchased from Sigma-Aldrich (USA). 2,4,6,-Tripyridy-S-triazine was obtained from Fluka Chemicals (Switzerland). Double diionized (DDI) water utilized from preparing mobile phase was purified by Milli-Q water system (Millipore Corp., Bedford, Mass., USA).

The raw herbs of Herbal medicine QQ (“QQ”) were purchased from different herbal medicinal stores.

The raw herbs of QQ were ground into very fine powder. The QQ extracts were obtained by refluxing 35 g of the QQ powder with 350 ml different percentage of ethanol with water for 30 minutes. The percentage of ethanol were used 0%, 25%, 50%, 75% and 100%. The residue of the extracts was filtered by 0.45 μm nylon filter, and the solvent of the extracts was evaporated under vacuum. To remove all the solvent completely, the dried extracts were further dried with freeze dryer for 24 hours. Fifteen QQ dried extracts were obtained from the three different sources as mention above. 5 mg/ml QQ dried extract was then dissolved with its extracting solvent, and analyzed by HPLC-DAD. The chemical compositions of the QQ extracts were separated with two buffer solutions and the gradient of the mobile is listed in Table 1. The flow rate and the injection volume of the extracts were 1.0 ml/min and 20 μl respectively. The detection wavelength used was 230 nm.

TABLE 1
Gradient of the mobile phase for the QQ extracts
in this study

| | Buffer A | |
|---|---|---|
| | 0.05M K₂HPO₄ (pH | Buffer B |
| Elution time (min) | 3.0):ACN = 95:5 | DDI:ACN = 20:80 |
| 0 | 100 | 0 |
| 10 | 90 | 10 |
| 15 | 90 | 10 |
| 40 | 77 | 23 |
| 45 | 67 | 33 |
| 70 | 17 | 83 |
| 80 | 0 | 100 |
| 90 | 100 | 0 |
| 95 | 100 | 0 |

Radical scavenging activities of the QQ extracts against stable DPPH free radical were determined spectrophotometrically. When DPPH free radical reacts with an antioxidant compound, which can donate hydrogen, it is reduced. The changes in colour from deep purple to pale yellow were measured at 515 nm via an UV/visible light spectrophotometer (Spectronic Gnensys 8, Rochester, USA) in this work.

In measuring radical scavenging activity of QQ extracts, firstly, prepare 0.025 mg/ml DPPH solution by dissolving 2.5 mg DPPH powder in 100 ml methanol in-suit. Mix 1.95 ml of methanolic DPPH solution with 50 ul of sample solution in 1 cm path length quartz cuvettes, and then the absorption of the DPPH-sample mixture (Aₛₐₘₚₗₑ) was measured at different time intervals (1, 2, 3, 4, 5, 10, 15, 20, 30 min etc.) until the reaction has gone to completion, when the absorbance change is equal to or smaller than 0.003 units per minute. Here, “completion” is indicated by the plateau in the plot of absorbance against time. For comparison, at the beginning, the extinction of the cuvette with 1.95 ml DPPH. Solution was measured as control (A_{control}) and absorption of MeOH-sample solution (A_{original}) containing 1.95 ml of MeOH and 50 ul of sample solution was recorded. The later datum is used to eliminate the absorption of sample solution via equation (1). All experiments were carried out in triplicate. After all measurements, the SR % was calculated by the following equation:

$$SR \% = [ 1 - \frac{( {A}_{sample} - {A}_{origonal} )}{{A}_{control}} ] \times 100 \% \qquad ( 1 )$$

Finally, SRₘₐₓ % of the sample concerned is obtained when the SR % achieved to plateau.

All data analysis was performed on a Pentium 4 personal computer. All programs for calculation were in-house programs in MATLAB® 7.2(The Mathworks, Natick, Mass.) for Chromatographic fingerprints are subjected to a number of experimental errors which should better be corrected prior to further data analysis. For chromatographic data, this means that all chromatograms should be of equal length and when chromatograms are placed as rows in a data matrix, the apexes of the corresponding peaks should be in the same columns of the matrix. Often chromatographic do not fulfill these requirements because of peak shifts, seen along the time axis. These shifts can be caused by variations in mobile phase composition or column temperature, column ageing, instrument instability and others. Therefore, a correction will be a must to align corresponding peaks. The techniques used for this purpose are, among others, correlation optimized warping, dynamic time warping, parametric time warping. However, all the above warping methods do not make full use of the spectral information from the complex herbal medicine system with multi-channel detectors. In this case, the UV spectral data are from HPLC-DAD measurements. In this patent, target peak alignment (TPA) has been utilized to correction retention shifts.

FIG. 2 shows the fingerprints of 15 QQ samples extracts of herbal medicine. These fingerprints are constructed from their total HPLC chromatogram.

The raw data set contains 15 chromatograms of 18000 sampling points length [15×18000]. Firstly, the number of sampling points is reduced by computing the average for each successive 6 sampling points. (Averaging every 6 sampling points is not excessive since in the raw data, the peaks are over-sampled) In this way, the length of the UV chromatograms is reduced to only 3000 sampling points. In FIG. 3, the reduced UV data set [15×3000] is plotted.

The peak alignment allows correcting peak shifts. As shown in FIG. 4, time shifts do exist in the chromatograms under research. The analytical signals were aligned by Target Peaks Alignments (TPA). The aligned and enlarged chromatograms are shown in FIGS. 5 and 6.

Regarding finding the active ingredients, the p-value for testing the hypothesis of correlation was set at 10⁻⁶. As shown in FIG. 7, one can find 6 parts, whose −log(p) is larger than 6. These 6 parts fall into are points between 260-275, 1570-1600, 1830-1860, 2180-2200, 2345-2356 and 2485-2499. However, the first four parts does not contain significant observable peaks. An inspection on FIG. 8 tells us that the parts between points 2300-2550 are possible active parts in QQ. And the components on retention time 47.02 (point 2351), time 47.28 (point 2364), time 49.48 (point 2364) are possible active components. In addition, this region has been confirmed by the preparation liquid chromatographic experiments, since it gives the most active fraction of QQ extract as prepared. An inspection on FIG. 9 tells us that the parts between points 310-330 and 580-600 are possible to have an antagonistic effect on the anti-oxidant assay.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method of finding active ingredients from a multi-component system comprising the steps:
grinding a multi-component system;
obtaining at least two solvent extracts;
drying said extract;
dissolving said dried extract;
generating a fingerprint of said multi-component system;
treating said fingerprint; and
locating active components from said fingerprint.

2. The method of finding active ingredients in claim 1, wherein obtaining said solvent extracts comprises refluxing said ground multi-component system with a solvent/water mixture.

3. The method of finding active ingredient in claim 2, wherein five solvent extracts are obtained.

4. The method of finding active ingredient in claim 3, wherein said five solvent extracts are obtained using solvent/water mixtures of 0% ethanol/100% water, 25% ethanol/75% water, 50% ethanol/50% water, 75% ethanol/25% water, and 100% ethanol/0% water.

5. The method of finding active ingredients in claim 1, wherein drying said extracts occurs by vacuum.

6. The method of finding active ingredients in claim 5, further comprising the step of further drying the extract by freezer dryer.

7. The method of finding active ingredients of claim 1, wherein dissolving said dried extract is performed to give a extract/solvent concentration from 3 mg/ml to 7 mg/ml.

8. The method of finding active ingredients of claim 1, wherein said solvent is ethanol.

9. The method of finding active ingredients of claim 1, wherein generating said fingerprint occurs with a hyphenated instrument.

10. The method of finding active ingredients of claim 8, wherein said hyphenated instrument is gas chromatography/mass spectrophotometer.

11. The method of finding active ingredients of claim 1, wherein treating said fingerprint occurs using a local target factor analysis.

12. The method of finding active ingredients of claim 1, wherein locating active components comprises locating components that exhibit antioxidant activity as determined by the fingerprint.

13. The method of finding active ingredient of claim 12, wherein locating said active components relies upon correlation analysis of P-values.

14. The method of finding active ingredients of claim 13, wherein said p-value is set at 10⁻⁶.
